(19) United States
(12) Patent Application Publication
(10) Pub. No.: US 2013/0116036 A1
(43) Pub. Date: May 9, 2013

(54) Method and layout for a craps game

(71) Applicants: Frank Mugnolo, Broadview, IL (US); Anthony Mugnolo, Broadview, IL (US); Leonardo Mancari, Lemont, IL (US); Robert C. DeAngeles, Downers Grove, IL (US)

(72) Inventors: Frank Mugnolo, Broadview, IL (US); Anthony Mugnolo, Broadview, IL (US); Leonardo Mancari, Lemont, IL (US); Robert C. DeAngeles, Downers Grove, IL (US)

(21) Appl. No.: 13/730,160

(22) Filed: Dec. 28, 2012

Related U.S. Application Data
(63) Continuation of application No. 11/983,119, filed on Nov. 7, 2007.
Application No. 11/983,119 is a continuation-in-part of application No. 11/890,348, filed on Aug. 6, 2007, now abandoned.
(60) Provisional application No. 60/922,763, filed on Apr. 10, 2007.

(51) Int. Cl. A63F 13/10

(52) U.S. Cl. CPC A63F 13/10
USPC 463/22; 273/274

(57) ABSTRACT

The invention includes methods of playing craps. Wagering area(s) are provided. Bets are placed on the areas. A come out roll is performed. Subsequent rolls are performed if the come out roll does not terminate the round, and a payout is awarded to players who placed Point 7 wagers if the come out roll is a point and the subsequent roll is a 7. An embodiment includes a 7 roll followed by a point roll. A payout is made to players who placed a 7 Point 7 wager if the come out roll is a 7. If the come out roll does not terminate the round, a payout is awarded to players who participated in the 7 Point 7 wager if the next come out roll is a point and the subsequent roll is a 7.

This application is a continuation-in-part of U.S. patent application Ser. No. 11/890,348, filed Aug. 6, 2007, and claims benefit of U.S. Provisional Application No. 60/922,763, filed Apr. 10, 2007.

### BACKGROUND OF THE INVENTION

1. Field of the Invention

The invention is directed to a game. In particular, the invention is directed to a well-known wagering game of chance, known as “craps.” More particularly, the invention is an improved method applicable to the game of craps and directed to a novel type of wager.

2. Description of the Prior Art

Standard craps is most often played at a casino or like venue. The game involves a shooter and a number of players, who wager on the outcome of game play performed by the shooter. The shooter uses dice in performing game play. The placing of wagers on the outcome of game play is at the heart of craps.

The details of game play and the rules in conventional craps are well known. However, to appreciate how the invention is applied to craps, it would be useful to summarize game play and some of the standard rules to provide a frame for describing the invention.

Craps is played on an elongated game table having a horizontal top surrounded by a sidewall to form a sunken pit or a game play arena or area. The game table has a number of marked areas that correspond to various wagers, and are so marked—upon which betting “chips” may be positioned. Many of the various wagers will be explained more fully below. In addition to the table, the game of craps requires use of a pair of identical dice, each of which is a cube-shaped game piece. Each of the dice has six faces. Each of the six faces of an individual die has a different arrangement of circular patches or pits, also known as pips, dots or spots, totaling respectively to one through six in number and wherein spots on opposite sides add up to seven.

In craps, played according to the standard rules, the player throwing or rolling the dice is known as the “shooter.” In short, a primary objective of craps is to bet whether the shooter will roll a selected number of dots or a certain combination of dots, determined by examining and adding the number of dots showing on upper faces of the dice after being rolled onto the game table and coming to rest on the table. The bet may also take the form of wagering on whether two or more rolls will generate a selected result.

The first roll of the dice, which is performed during the come-out phase and is known as the come-out roll or initial come-out, the shooter wins by rolling either a 7 or an 11. Rolling a 7 or an 11 at the come-out roll is known as “passing.” If the shooter rolls a 2, 3, or 12, this is known as a “craps” and the shooter loses. Rolling any other number (4, 5, 6, 8, 9, or 10) is called the “point.”

Rolling a point during the come-out roll brings the game into the point phase. The basic objective of the game at the point phase is to roll the point again before a 7 is rolled. Winning at this stage of the game is also known as passing. If a 7 is rolled before the point number, the shooter has “sevened-out” or has rolled an “out 7” and loses. If the shooter rolls neither the point nor a 7, the round continues and the shooter continues to rolls the dice.

The game of craps becomes more complicated when the large number of betting options is considered. Players are permitted to place wagers on the outcome of the shooter's dice rolls. The craps player may make simple bets, consisting of the selection of one betting option, or combinations of betting options in the hopes of increasing the odds of winning, increasing the possible amount of winnings or hedging a bet, for example. The complex types and combinations of craps wagers illustrate the subtle strategy, which may be employed during game play.

The typical and most simple wager is one of the “pass” or “pass line” and “don't pass” bets. These wagers must be committed to and placed before the come-out roll. The player with a pass line bet wins on the come out roll if the roll totals 7 or 11. The pass line bet is also a wager that a point will be rolled before an out 7 on any roll subsequent to the come-out roll.

A don't pass wager is the opposite of a pass bet. In placing the don't pass wager, the player is betting that the shooter will roll a 2, 3 or 12 on the come-out roll, or an out 7 before making the point. As such, this bet is a wager against the shooter and sometimes called a “wrong” bet.

Similar to the pass line wager, the “come” bet can only be taken after a point is established. It is a wager that the shooter will roll a 7 or 11 on the next roll, or make a point. A come bet can be made on every roll of the dice only after the shooter has established a point. Analogous to the “don't pass” wager, the “don't come” wager can only be taken after a point is established. It is a wager that the shooter will roll a 2, 3 or 12 on the next roll, or will not make the point before rolling a 7.

An “odds bet” is one or more additional bet made on an established pass, don't pass, come or don't come bet. For example, the “place to win” bet is a bet that the shooter will roll the number that a “win” bet is placed on, i.e., 4, 5, 6, 8, 9 or 10, before a 7 is rolled. The “place to lose” bet is a bet that the shooter will roll a 7 before the number that a “lose” bet is placed on, i.e., when a 4, 5, 6, 8, 9 or 10, is rolled.

The proposition bets are wagers that the next roll will be a specific number. These include the 2, 3, 7, 11, and 12 bets, the “any craps” bet, the “field,” “hop” and “horn” bets. The “field” bet, for example, is a single roll bet that the shooter will roll a 2, 3, 4, 9, 10, 11 or 12, on the next roll. Other bets, which tend to be played less frequently, include the “place number” bets and the “proposition” bets. A place number bet is a wager that a particular number will roll before a 7 does, or vice versa. These include the “place,” “buy,” “lay” and “lose” bets, the “big 6” and “big 8,” and finally the “hard 4,” “hard 6,” “hard 8” and “hard 10.” A “hard ways bet” is a bet that the shooter will roll either a 2, 3, 4, or 5 as a double, before it is thrown in any other combination, or before a 7 is rolled. An “any seven” is a bet that the shooter will roll a 7 on the next roll. An “any craps” is a bet that the shooter will roll a 2, 3 or 12 on the next roll. A “craps two” is a bet that the shooter will roll a 2 on the next roll. A “craps twelve” is a bet that the shooter will roll a 12 on the next roll. A “craps three” is a bet that the shooter will roll a 3 on the next roll. An “eleven” is a bet that the shooter will roll an 11 on the next roll. A “big 6” is a bet that a 6 will be rolled before a 7. A “big 8” is a bet that an 8 will be rolled before a 7.

This review of many of the wagers and game play of the game of craps is in no way complete, and should be understood to encompass a general scheme of the game for illustrative purposes only. Furthermore, it will be understood that the rules may be different in different venues and one with ordinary skill in the art will understand that the invention may be applied to most or all of these versions of craps as well. It will be understood that the embodiments of the invention detailed herein are contemplated as being incorporated into any and all versions of craps played and any current and future methods of playing craps.

The game of craps is made rich, challenging and interesting by the diverse array of wagers and combinations of wagers available to the players. For at least this reason, there is a demand for the development of new wagering options; especially those which are not complicated to incorporate into any versions of craps. The invention satisfies the demand.

### SUMMARY OF THE INVENTION

The invention takes, in one embodiment, the form of a wager in an otherwise standard game of craps. In the alternate, the invention may take the form of a wager in a game of craps, which deviates from a standard game of craps. The wager is easily performed and does not require substantial revisions to the rules or game play table for a standard craps game. The invention is an improvement to the games of craps in the form of a simply executed bet, which provides the player a new wagering option, referred to hereinafter as a “Point 7” and alternately a “P7” or “7”. An alternate embodiment of the invention will be referred to as “7P” or “7 Point” or “7.” Yet another alternate wager, which may be considered a variant of the Point 7 wager, is also set out herein and referred to hereinafter as a “7 Point 7” and alternately “7P7” or “7.7”.

The Point 7, 7 Point and 7P7 bets are wagers made during a craps game, which may otherwise be played according to conventional rules of play. The craps table will preferably be modified to include a wager area indicated as corresponding to a Point 7, and/or a 7 Point wager and/or a 7P7 wager for each participating player. The outcome of the wagers is determined according to alternate embodiments of the invention and is thus dependent upon the course of play of the craps game, wherein all other wagers under conventional rules may be independent of whether or not a Point 7 wager, a 7 Point wager or a 7P7 wager is placed.

The wagers are each preferably made before the shooter performs the initial come out dice toss. Each player wishing to make one or both wagers may do so by making a Point 7, 7 Point or a 7P7 wager indication by placing his or her chip(s) on the appropriate player wager area on the lay-out directly. In the alternate, and in most conventional craps venues, the player conveys a wager request to the dealer, who places the wager on the appropriate area of the table for the player.

As noted above, in a method of game play, once a Point 7, 7 Point or a 7P7 wager is made by placement of at least one selected wager or chip(s) on each participating player's respective player betting area, a dealer will retrieve the chip(s) and place the chip(s) upon the corresponding wager areas, designated for a Point 7, 7 Point or a 7P7 respectively. These wagers will then remain in the respective areas until the outcome of game play result in a payout; a scenario where the wager remains on the table and further game play determines the outcome; or a loss, in response to outcomes of dice throws by the shooter.

The shooter throws his or her initial come out toss. If the outcome is a 2, 3, 7, 11 or 12, no payout is made to each player who made a Point 7 wager, and the players lose their wager.

If the outcome is a point (4, 5, 6, 8, 9, or 10), the dealer notes the point as usual, and play continues. If the next roll is a 7, i.e., the roll immediately after establishing the point, each player who has made the Point 7 wager wins the bet (e.g., 8 for 1 or 7:1). If the roll immediately after establishing the point is not a 7, players who have made the Point 7 wager lose their bet.

The 7 Point 7 wager is made before the shooter performs the initial come out dice toss. Each player wishing to make a 7 Point 7 wager may do so by making a 7 Point 7 wager indication by placing his or her chip(s) on the appropriate player wager area on the lay-out directly below their gaming position. In the alternate, and in most conventional craps venues, the player conveys a wager request to the dealer, who places the wager on the 7 Point 7 area of the table for the player.

After wagers are placed, the come out roll occurs to generate a number according to the combined number of dots showing from the two dice rolled. If the come out roll is a 7, then the player who made the 7P7 wager may win a payout (for example at 2:1). If the come out roll is a 2, 3, 11 or 12 the 7P7 wager loses. If a point is established (i.e., 4, 5, 6, 8, 9, 10), the dice is rolled again. If the roll immediately after establishing the point is a 7, the player receives a payout (for example at 3:1). If the roll immediately after establishing the point is not a 7, the players who have made the 7P7 wager lose the bet.

Accordingly, it is one aspect of the invention to provide an improved craps game having enhanced enjoyment based on a novel set of optional wagers including generally the steps of, in a preferred embodiment, of establishing a point, which is immediately followed by a 7, wherein the player having made the Point 7 wager wins. Another aspect of the invention is to provide an improved craps game having enhanced enjoyment based on a novel wager, wherein if a 7 is rolled on the come out roll players who have made the wager receive a payout and if the come out roll establishes a point, which is immediately followed by a roll of a 7 (i.e., according to the 7P7 embodiment), players who have made the wager receive a payout.

Another aspect of the invention includes a method of playing a craps game, wherein the game includes a game table layout having a plurality of designated wagering areas, including the steps of providing on the game table layout at least one 7 Point wagering area, placing one or more bets on one or more of the at least one 7 Point wagering area, performing a first roll, performing a subsequent roll immediately following the first roll, and awarding a payout to each of the players who participated in said placing of a bet on the 7 Point wagering area if the first or come out roll is a 7 and the roll immediately after the 7 roll is a point.

This, and additional objects, advantages, features and benefits of the invention will become apparent from the following specification.

### BRIEF DESCRIPTION OF THE DRAWINGS

FIG. 1 is an embodiment of a portion of game play area, table or felt of a craps game incorporating Point 7 wagering areas, 7 Point wagering areas and 7 Point 7 wagering areas;

FIG. 2 is a flow chart illustrating methods of embodiments of the invention;

FIG. 3 is a flow chart illustrating alternate methods of embodiments of the invention; and

FIG. 4 is a flow chart illustrating yet another alternate method of embodiments of the invention.

### DETAILED DESCRIPTION OF THE PREFERRED EMBODIMENTS

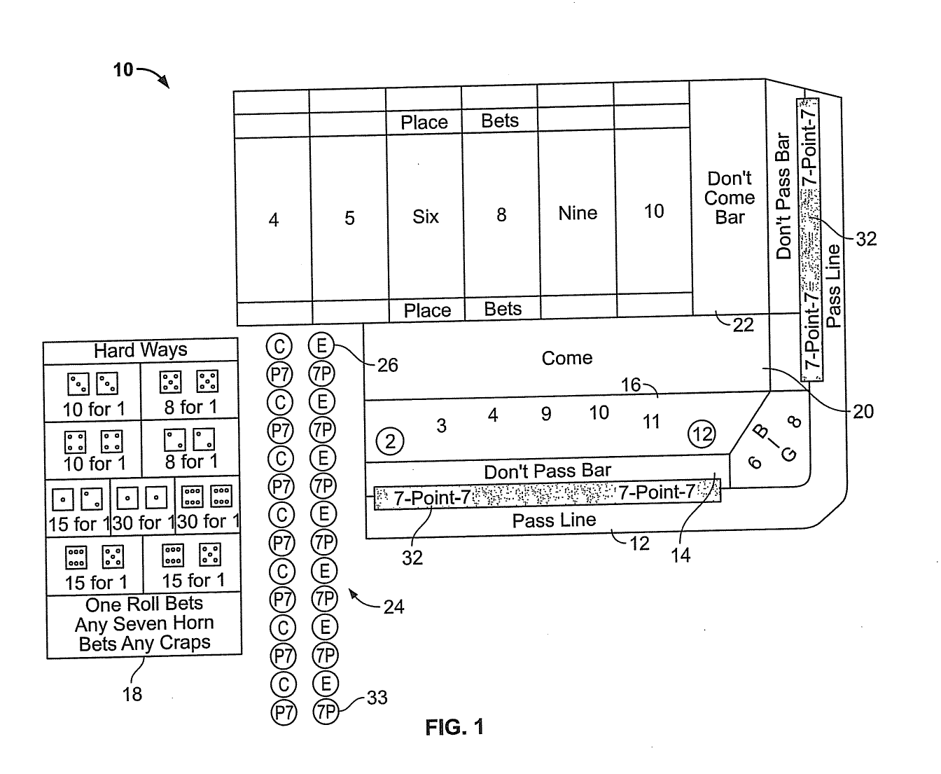

Referring to the drawings, FIG. 1 depicts a partial view of a game play area or table or felt 10 of a craps game table for a game of craps according to one embodiment of the invention. The game play area 10 includes the conventional wagering areas such as the pass bar 12, don't pass bar 14, field 16, any craps 18, come 20 and don't come 22. In one embodiment of the invention, a Point 7 wagering area 24 is provided on the game play area 10. Preferably, individual Point 7 areas 26 will be provided for each potential player. Each of the Point 7 areas 26 may be indicated as a P7 enclosed within a circle or other shaped area. Furthermore, Point 7 wagering areas 26 may be any suitable shape or area, circular, rectangular, triangular, star shaped and so on, and may include any suitable designation or icon or indication to identify that the area is for use in the P7 wager. The Point 7 areas 26 may be anywhere on the game play area 10.

The invention contemplates positioning the Point 7 wager at any usable position on the game play area 10. In the table form of the game, a pair of dice (not shown) is physically rolled onto the game play area 10 of the craps game table. Other forms of the game, video, arcade, internet-delivered and so on are contemplated by the invention.

The invention may be incorporated into any craps or craps-like game. It will be understood that the game play area of aspects of the craps game incorporating the invention may be virtual, i.e., depicted by a video screen or the like in an electronic representation of craps. The screen may be part of a stand alone computer display whereby most or all aspects of the craps game is played on the computer. The screen may be part of an Internet game of craps depicted on a computer screen or similarly in communication with a remote game system via a wired or wireless connection or some other form of communication. The craps game may be a hybrid version of the above, wherein a screen displays the game play and people perform other aspects or steps of the game. The dice may be virtual and randomly generated by a computer or the like. It will be understood that the invention may be incorporated into any craps or craps-like game regardless of how the game is presented, played, displayed and so on and not limited by how the game is executed.

The invention also contemplates providing 7P7 areas 32 for enabling players and others to place a 7P7 wager. The 7P7 areas 32 may be provided in addition to, or in place of, the Point 7 areas 26. The number of 7P7 areas 32 should be sufficient to permit all of the players to elect to place a 7P7 wager. Of course, lesser numbers of Point 7 areas 26 or 7P7 areas 32 may be provided. Like the Point 7 areas 26, the 7P7 areas may be any suitable shape or area, circular, rectangular, triangular, star shaped and so on, and may include any suitable designation or icon or indication to identify that the area is for use in the 7P7 wager. For example, the 7P7 areas 32 may include “7P7” within a circle or “7.7” or any other suitable marking. The areas 32 for the 7 Point 7 wager may be a bar between the Pass Line 12 and the Don't Pass Bar 14 as presently shown. It will be understood that the 7P7 areas 32 can be anywhere on the play area 10.

The invention also contemplates providing 7P areas 33 for enabling players and others to place a 7P wager. The 7P areas 33 may be provided in addition to, or in place of the Point 7 areas 26. The number of 7P areas 33 should be sufficient to permit all of the players to elect to place a 7P wager. Of course, other numbers and types of Point 7 areas 26, 7P7 areas 32 and/or 7P areas 33 may be provided. Like the Point 7 areas 26, and the 7P7 areas, the 7P area(s) 33 may be any suitable shape or area, circular, rectangular, triangular, star shaped and so on, and may include any suitable designation or icon or indication to identify that the area is for use in the 7P wager. For example, the 7P areas 33 may include “7P” within a circle or “7.” or any other suitable marking. The areas 33 for the 7 Point wager may be a bar between the Pass Line 12 and the Don't Pass Bar 14 as presently shown. It will be understood that the 7P areas 33 can be anywhere on the play area 10.

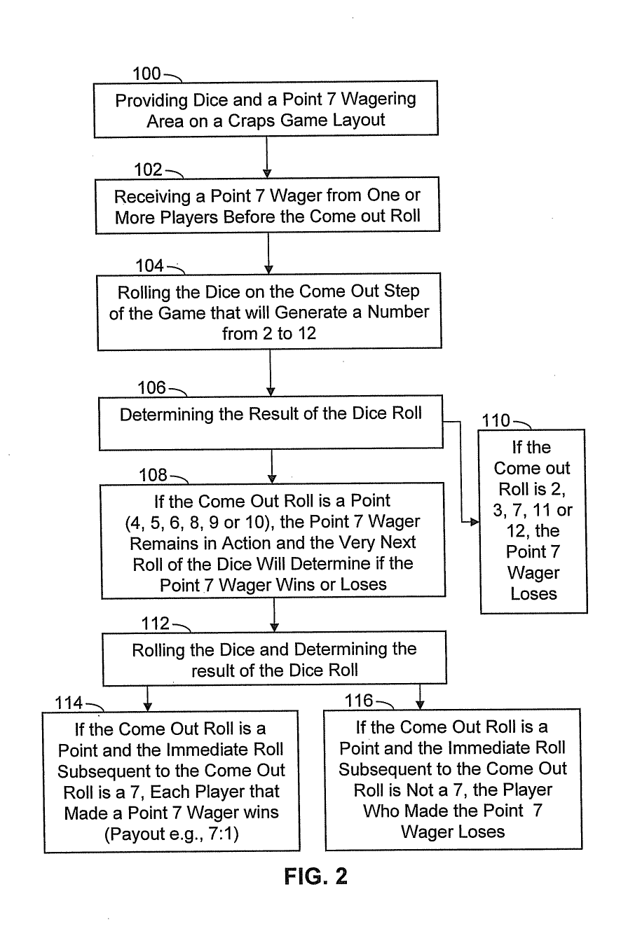

Referring now to FIG. 2, a flowchart is provided, which depicts methods of playing craps incorporating the Point 7 wagering aspect of the invention. It is to be understood that the term “shooter” means a person or persons who shoot from an initial come out to a seven out. In that the person who is serving as the shooter may leave the game in mid-play, any player who serves thereupon in substitution as shooter in his or her place is included by, and within the meaning of, the term shooter.

Without being limited by the example given herein to illustrate embodiments of the invention, the game may be considered to begin with the provision 100 of a pair of dice and a game table or game play area 10 (see FIG. 1), and where the game table has been provided 100 with at least one Point 7 wager area 26. Players may play by placing one or more bets in the areas 12-33 (FIG. 1) marked for wagering before the shooter rolls the dice.

The Point 7 wager 102 is made before the shooter performs the initial come out dice toss. Each player making a Point 7 wager 102 does so by making a Point 7 wager indication by placing his or her chip(s) on the appropriate player wager area 26 (see FIG. 1) on the lay-out directly below their gaming position. In the alternate, and more typically, the player may request the dealer place the wager on the Point 7 area 26 of the table and in response, the dealer places the wager.

As noted above, in a method of game play, once a Point 7 wager is made 102 by placement of at least one selected chip or some type of indicator on each participating player's respective player betting area, a dealer will retrieve the chip(s) and place the chip(s) upon the corresponding wager areas, designated for a Point 7. These Point 7 wagers will then remain in the respective wager areas until the Point 7 wagers are won or lost, in response to outcomes of dice throws by the shooter.

The shooter then throws his or her initial come out toss 104. A determination is made of the result of the dice roll 106. There is no payout 110 to players who made the Point 7 wager where the roll totals 2, 3, 7, 11, or 12. In this case, the round is over and the player loses the wager.

If the shooter throws his or her initial come out toss 104 and the outcome of the dice roll 106 is a point (4, 5, 6, 8, 9, or 10) the dealer notes the point as usual and play continues 108. If the next roll 112 is a 7, i.e., from the roll immediately after establishing the point, each of the players who have made the Point 7 wager wins the bet 114, and receives a payout (e.g., at 8 for 1, or 7:1). If the roll immediately after establishing the point is not a 7, players who have made the Point 7 wager lose the bet 116, and the wager is collected.

It will be understood that all other rules of the game of craps are unaffected by the invention.

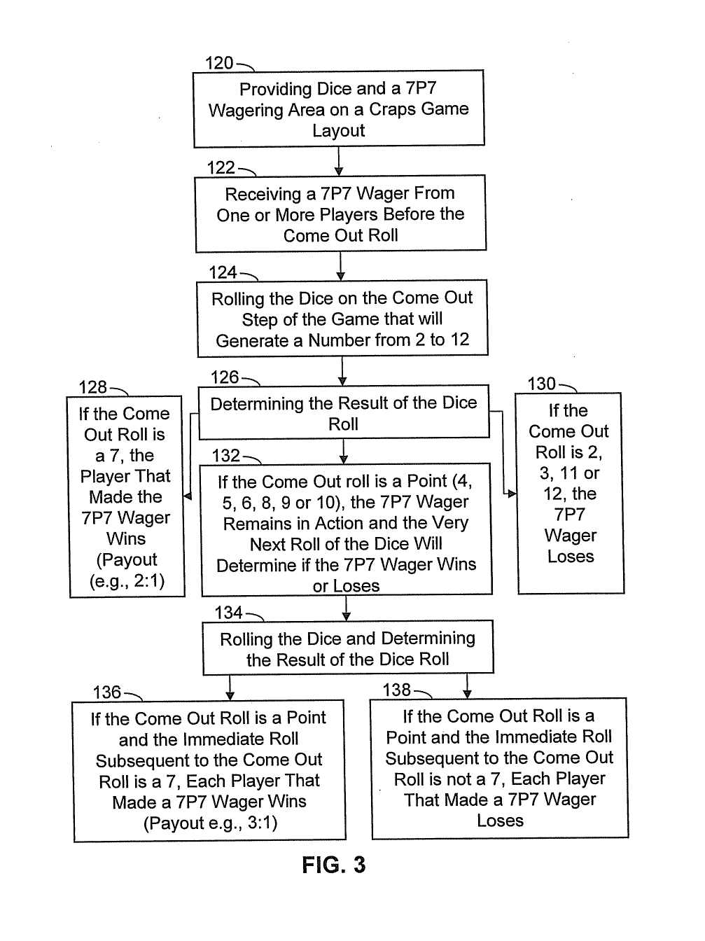

Referring now to FIG. 3, a flowchart is provided, which depicts methods of playing craps incorporating the 7 Point 7 wagering aspect of the invention. Without being limited by the example given herein to illustrate embodiments of the invention, the game may be considered to begin with the provision 120 of a pair of dice and a game table or game play area 10 (see FIG. 1), and where the game table has been provided 120 with a 7 Point 7 wager area. Players may play by placing one or more bets in one or more of the areas 32 marked for wagering (see FIG. 1) before the shooter rolls the dice. The 7 Point 7 wager area may be anywhere on the game play area 10.

The 7 Point 7 wager 122 is made before the shooter performs the initial come out dice toss. Each player making a 7 Point 7 wager does so by making a 7 Point 7 wager indication by placing his or her chip(s) or other markers on an appropriate player wager area 32 (see FIG. 1), typically on the lay-out directly below their gaming position. In the alternate, and more typically, the player may request the dealer place the wager on their 7 Point 7 area 32 of the table and in response, the dealer or other authorized person places the wager.

As noted above, in a method of game play, once a 7 Point 7 wager is made 122 by placement of at least one selected chip or some type of indicator on each participating player's respective player betting area, a dealer will retrieve the chip(s) and place the chip(s) upon the corresponding wager areas, designated for a 7 Point 7. The 7 Point 7 wagers will then remain in the respective wager areas 32 until the 7 Point 7 wagers are won or lost, in response to outcomes of dice throws by the shooter.

The shooter then throws his or her initial come out toss 124. A determination is made of the result of the dice roll 126. If the outcome is a 7, a payout is made 128 to each player who made the 7 Point 7 wager (e.g., at 2:1). In this case, the round is over. If the come out roll is a 2, 3, 11 or 12, the 7 Point 7 wager loses 130 and the round is over and the player loses the wager.

If the shooter throws his or her initial come out toss 124 and the outcome of the roll 126 is a point (4, 5, 6, 8, 9, or 10) the dealer notes the point as usual and play continues 132. If the next roll 134 is a 7, i.e., from the roll immediately after establishing the point, each of the players who have made the 7 Point 7 wager wins the bet, and receives a payout 136 (e.g., 3:1). If the roll immediately after establishing the point is not a 7, players who have made the 7 Point 7 wager lose the bet 138, and the wager is a loser and is collected.

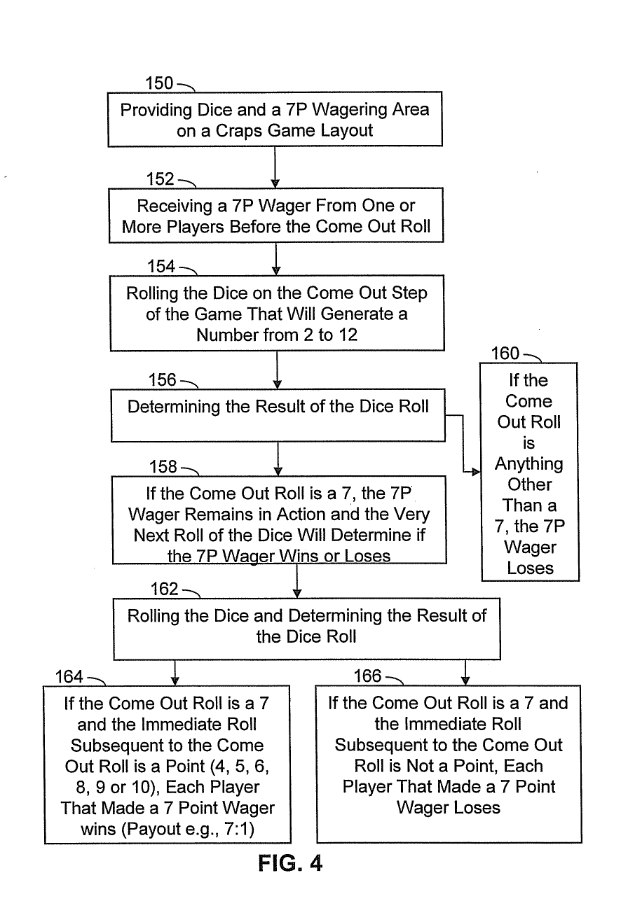

Referring to FIG. 4, a flowchart is provided, which depicts methods of playing craps incorporating the 7 Point (7P) wagering aspect of the invention. Without being limited by the example given herein to illustrate embodiments of the invention, the game may be considered to begin with the provision 150 of a pair of dice and a game table or game play area 10 (see FIG. 1), and where the game table has been provided 150 with a 7 Point wager area 33. Players may play by placing one or more bets in one or more of the areas 33 marked for wagering (see FIG. 1) before the shooter rolls the dice. The 7 Point wager area may be anywhere on the game play area 10.

The 7 Point wager 152 is made before the shooter performs the initial come out dice toss. Each player making a 7 Point wager does so by making a 7 Point wager indication by placing his or her chip(s) or other markers on an appropriate player wager area 33 (see FIG. 1), typically on the lay-out directly below their gaming position. In the alternate, and more typically, the player may request the dealer place the wager on their 7 Point area 33 of the table and in response, the dealer or other authorized person places the wager.

As noted above, in a method of game play, once a 7 Point wager is made 152 by placement of at least one selected chip or some type of indicator on each participating player's respective player betting area, a dealer will retrieve the chip(s) and place the chip(s) upon the corresponding wager areas, designated for a 7 Point. The 7 Point wagers will then remain in the respective wager areas 32 until the 7 Point wagers are won or lost, in response to outcomes of dice throws by the shooter.

The shooter then throws his or her initial come out toss 154. A determination is made of the result of the dice roll 156. If the outcome is a 7, the 7 Point wager remains in action and the next roll determines if the 7P wager wins or loses 158. In this case, the round is over for some players, but the player making the 7 Point wager must wait for the next roll to see if the 7 Point wager will win or lose. If the shooter throws his or her initial come out toss 158 and the outcome of the roll is a 7, the dealer notes the 7 Point wagers and for the players who placed the 7 Point wager play continues 158. If the come out roll is any total other than a 7, the 7 Point wager loses 160.

If the next roll 162 is a point, i.e., if the roll immediately after establishing a 7 totals 4, 5, 6, 8, 9 or 10, each of the players who have made the 7 Point wager wins the bet, and receives a payout 164.

If the come out roll is a 7, the players making the 7 Point wager lose or win depending on the outcome of the roll immediately after the 7 is established. The dice roll immediately after the come out roll of a 7 is performed at step 162. If the roll is not a point (totaling 4, 5, 6, 8, 9 or 10), then the 7 Point wager loses 166.

To those skilled in the art to which this invention pertains, the above-described preferred embodiment may be subject to change or modification. Such change or modification can be carried out without departing from the scope of the invention, which is intended to be limited only by the scope of the appended claims.

1-5. (canceled)

6. A method of playing a craps game, wherein the game includes a game table layout having a plurality of wagering areas, comprising:
providing on the game table layout a designated wagering area;
receiving a bet on the designated wagering area;
performing a come out roll;
if the come out roll is anything other than a 7, terminating the wager with no payout,
if the come out roll is a 7, continuing the bet without a payout and performing a subsequent roll immediately following the come out roll; and
after the subsequent roll, terminating the wager and awarding a payout only if the subsequent roll is a point, wherein the payout is no more than the actual odds against rolling a 7 on the come out roll and a point on the subsequent roll.

7. The method of claim 6, wherein game play of said craps game is performed on one of a craps game felt, a craps game table, a video game display craps game table, or a computer monitor.

8. The method of claim 6, wherein a dice outcome is randomly generated during game play of said craps game.

9. The method of claim 8, wherein a computer randomly generates the dice outcome during game play of said craps game.

10-19. (canceled)

20. The method of claim 6, wherein the payout is made at 7:1.

21. A non-transitory computer readable medium storing a computer program for performing the method of claim 6.

22. A non-transitory computer readable medium storing a computer program for performing the method of claim 7.

23. A non-transitory computer readable medium storing a computer program for performing the method of claim 8.

24. A non-transitory computer readable medium storing a computer program for performing the method of claim 9.

25. A non-transitory computer readable medium storing a computer program for performing the method of claim 20.
